(19) United States
(12) Patent Application Publication
(10) Pub. No.: US 2026/0046828 A1
(43) Pub. Date: Feb. 12, 2026

(54) METHOD AND APPARATUS FOR EFFICIENT LOCATION SERVICES IN WIRELESS COMMUNICATIONS NETWORKS

(71) Applicant: Samsung Electronics Co., Ltd., Suwon-si (KR)

(72) Inventors: Dongeun SUH, Suwon-si (KR); Jicheol LEE, Suwon-si (KR); Hoyeon LEE, Suwon-si (KR)

(21) Appl. No.: 19/295,398

(22) Filed: Aug. 8, 2025

(30) Foreign Application Priority Data
Aug. 8, 2024 (KR) 10-2024-0106381

(51) Int. Cl. H04W 64/00; H04W 12/0471; H04W 12/63

(52) U.S. Cl. CPC H04W 64/00; H04W 12/0471; H04W 12/63

(57) ABSTRACT

The disclosure relates to a 5G or 6G communication system for supporting a higher data transmission rate. An embodiment of the disclosure may disclose a method performed by a location management function (LMF), and the method may include transmitting, to an access and mobility management function (AMF), a subscription request message including an assistance data type and an event identifier (ID) indicating a number of user equipments (UEs) in a geographical area; receiving, from the AMF, a number of UEs in the geographical area, wherein the UEs are associated with the assistance data type; determining whether to perform broadcast of network assistance data based on the number of UEs in the geographical area; and transmitting, to the AMF, a transfer request message including network assistance data in response to determination of performing broadcast.

### CROSS-REFERENCE TO RELATED APPLICATION

This application is based on and claims priority under 35 U.S.C. § 119 to Korean Patent Application No. 10-2024-0106381, filed on Aug. 8, 2024, in the Korean Intellectual Property Office, the disclosure of which is incorporated by reference herein in its entirety.

### BACKGROUND

### 1. Field

The disclosure relates to a method and apparatus for providing efficient location services in a wireless communication system.

### 2. Description of Related Art

5th generation (5G) mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### SUMMARY

The disclosure aims to improve the efficiency of providing location services in a wireless communication system.

According to an embodiment of the present disclosure, there is provided a method performed by a location management function (LMF) in a wireless communication system, comprising transmitting, to an access and mobility management function (AMF), a subscription request message including an assistance data type and an event identifier (ID) requesting a first number of user equipments (UEs) in a geographical area; receiving, from the AMF, the first number of UEs in the geographical area, wherein the UEs are associated with the assistance data type; determining whether to broadcast network assistance data based on the first number of UEs in the geographical area; and transmitting, to the AMF, a transfer request message including network assistance data in response to determining that the network assistance data is broadcast.

In an embodiment, the subscription request message further includes an indicator requesting a number of UEs provided with a ciphering key and the number of UEs in the geographical area indicates a number of UEs provided with the ciphering key.

In an embodiment, the subscription request message further includes a threshold value for the first number of UEs in the geographical area.

In an embodiment, the geographical area corresponds to a tracking area identity (TAI).

In an embodiment, the UEs are associated with a mobile-originated location request (MO-LR).

According to an embodiment of the present disclosure, there is provided a method performed by an access and mobility management function (AMF) in a wireless communication system, comprising receiving, from a LMF, a subscription request message including an assistance data type and an event ID indicating a first number of UEs in a geographical area; transmitting, to the LMF, the first number of UEs in the geographical area, wherein the UEs are associated with the assistance data type; receiving, from the LMF, a transfer request message including network assistance data; and transmitting, to a radio access network (RAN) node, the network assistance data.

In an embodiment, the subscription request message further includes an indicator requesting a second number of UEs provided with a ciphering key and the first number of UEs in the geographical area indicates the second number of UEs provided with the ciphering key.

In an embodiment, the subscription request message further includes a threshold value for the first number of UEs in the geographical area, and a transmission of the first number of UEs in the geographical area is performed based on the threshold value.

In an embodiment, the geographical area corresponds to a TAI.

In an embodiment, the UEs are associated with a MO-LR.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an architecture of a 5GS for media services in a wireless communication system according to various embodiments of the disclosure.

FIG. 2 illustrates a method for counting the number of UEs that have been provided with a ciphering key according to various embodiments of the disclosure.

FIG. 3 illustrates a method for broadcasting network assistance data based on various numbers of UEs according to various embodiments of the disclosure.

FIG. 4 illustrates a method for determining whether to provide assistance data based on the AMF according to various embodiments of the disclosure.

FIG. 5 illustrates a structure of a UE according to various embodiments of the disclosure.

FIG. 6 illustrates a structure of a network entity according to various embodiments of the disclosure.

### DETAILED DESCRIPTION

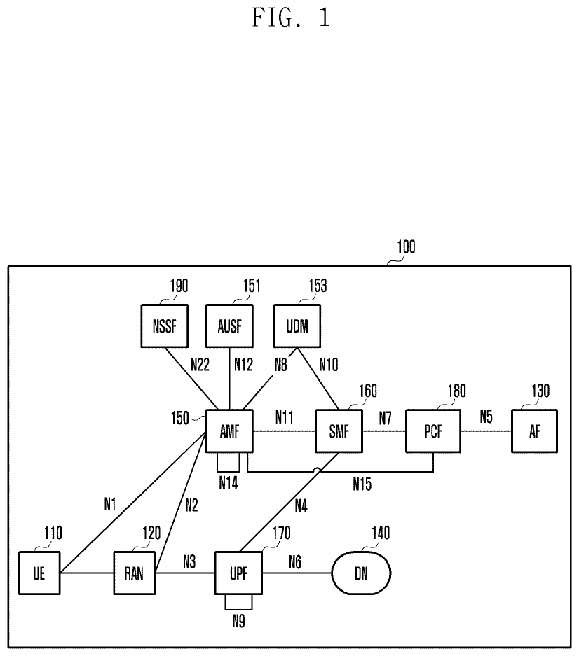

FIGS. 1 through 6, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

In describing the disclosure below, upon determining that a detailed description of a related known function or configuration may unnecessarily obscure the subject matter of the disclosure, the detailed description will be omitted.

For the same reason, some components in the attached drawings are exaggerated, omitted, or schematically depicted.

It will be appreciated that blocks of a flowchart and a combination of flowcharts may be executed by computer program instructions. These computer program instructions may be loaded on a processor of a general purpose computer, special purpose computer, or programmable data processing equipment, and the instructions executed by the processor of a computer or programmable data processing equipment create a means for carrying out functions described in blocks of the flowchart. To implement the functionality in a certain way, the computer program instructions may also be stored in a computer usable or readable memory that is applicable in a specialized computer or a programmable data processing equipment, and it is possible for the computer program instructions stored in a computer usable or readable memory to produce articles of manufacture that contain a means for carrying out functions described in blocks of the flowchart. As the computer program instructions may be loaded on a computer or a programmable data processing equipment, when the computer program instructions are executed as processes having a series of operations on a computer or a programmable data processing equipment, they may provide operation for executing functions described in blocks of the flowchart.

Each block of a flowchart may correspond to a module, a segment or a code containing one or more executable instructions for executing one or more logical functions, or to a part thereof. It should also be noted that functions described by blocks may be executed in an order different from the listed order in some alternative cases. For example, two blocks listed in sequence may be executed substantially at the same time or executed in reverse order according to the corresponding functionality.

In the disclosure, a base station (BS) is a main entity that performs resource allocation for terminals, and may be at least one of gNode B, eNode B, Node B, radio access unit, base station controller, or node on a network. A terminal may be a user equipment (UE), a mobile station (MS), a cellular phone, a smartphone, a computer, or a multimedia system capable of performing a communication function. In the following description, the NR or 5G system may be described as an example, but the embodiments of the disclosure may be applied to other communication systems having similar technical backgrounds or channel configurations. In addition, as those skilled in the art will understand, the disclosure can be applied to other communication systems through some modifications without significantly departing from the scope of the disclosure.

Hereinafter, embodiments of the disclosure will be described in detail with reference to the attached drawings.

FIG. 1 illustrates an architecture of a 5G system (5GS) for media services in a wireless communication system according to various the disclosure.

The 5G mobile communication network is composed of a 5G UE (user equipment, terminal), a 5G RAN (radio access network, base station, BS, gNB (5G nodeB), eNB (evolved nodeB)), and a 5G core network. The 5G core network is composed of network functions, such as the access and mobility management function (AMF) that provides UE mobility management functions, the session management function (SMF) that provides session management functions, the user plane function (UPF) that performs data transfer functions, the policy control function (PCF) that provides policy control functions, the unified data management (UDM) that provides management functions for data such as subscriber data and policy control data, and the unified data repository (UDR) that stores data of various network functions such as UDM.

In the 3GPP system, a conceptual link connecting NFs within the 5G system is defined as a reference point. The following are examples of a reference point included in the 5G system architecture represented in FIG. 1:
N1: Reference point between UE and AMF;
N2: Reference point between (R)AN and AMF;
N3: Reference point between (R)AN and UPF;
N4: Reference point between SMF and UPF;
N5: Reference point between PCF and AF;
N6: Reference point between UPF and DN;
N7: Reference point between SMF and PCF;
N8: Reference point between UDM and AMF;
N9: Reference point between two core UPFs;
N10: Reference point between UDM and SMF;
N11: Reference point between AMF and SMF;
N12: Reference point between AMF and AUSF (authentication server function);
N13: Reference point between UDM and AUSF;
N14: Reference point between two AMFs; and/or
N15: Reference point between PCF and AMF for non-roaming scenario, and between PCF in the visited network and AMF for roaming scenario

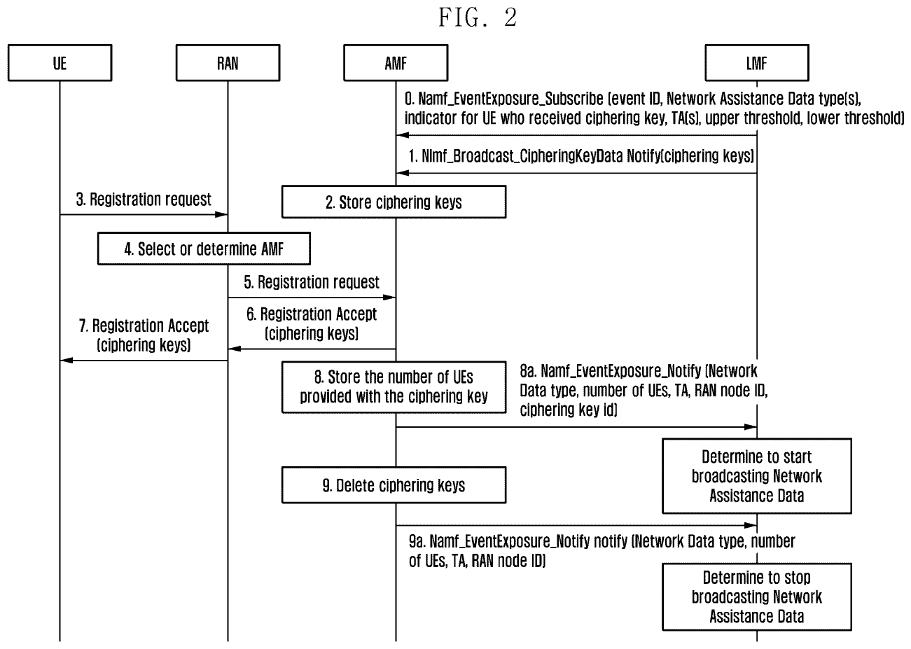

FIG. 2 illustrates a method for counting the number of UEs that have been provided with a ciphering key according to various embodiments of the disclosure.

0. To determine whether to transmit broadcast information about a network assistance data type to the base station, the location management function (LMF) may transmit a Subscription request message to the AMF to obtain information about the number of UEs that require the corresponding network assistance data type.

This message may include the following information:
Event ID: an event ID indicating the number of UEs in a geographical area is included;
Network assistance data type(s): the network assistance data type to subscribe to may be included. If using a ciphering key, the LMF may include an indication for requesting the number of UEs that have been provided with the ciphering key;
Area information: the TA(s) or RAN node ID(s) to subscribe to may be included;
Upper threshold: an upper threshold may be included if the LMF requests event reporting (notification) when the number of UEs of interest reaches the upper threshold; and/or
Lower threshold: a lower threshold may be included if the LMF requests event reporting (notification) when the number of UEs of interest reaches the lower threshold.

1. The LMF invokes the Nlmf_Broadcast_CipheringKeyData Notify service operation towards the AMF with one or more ciphering keys used for ciphering (i.e., encryption) the network assistance data broadcast to the UE. For each ciphering key, the LMF may include information about ciphering key value, ciphering key ID, validity time, applicable tracking areas (TAs), and network assistance data type(s) (for example, it may represent a GNSS assistance data type. A GNSS assistance data type may be associated with a specific positioning SIB type (i.e., type of message broadcast by the base station)).

2. The AMF stores the ciphering keys including validity time, applicable tracking area, and applicable broadcast assistance data type (network assistance data type).

3. The UE may transmit a Registration request message to the RAN node. This Registration request may be transmitted as part of mobility management, or the Registration request may be transmitted specifically to request and obtain a ciphering key. In this case, the UE may include an indication that a ciphering key is required in the Registration request message.

4. The RAN node may select a new AMF if the UE is in the CM idle state, and may determine the AMF if the UE is in the CM connected state.

5. The RAN node may forward the Registration request message to the AMF.

6. The AMF may return a Registration accept message to the RAN node. If the UE subscribes to receive ciphered broadcast data, the AMF may include in the Registration accept message one or more ciphering keys applicable to the TA in which the UE is currently located. In addition, for each encryption key, the AMF may include ciphering key value, ciphering key ID, validity time, applicable TA(s), and applicable network assistance data type(s).

If a data type to be counted for the associated network assistance data type(s) is included in the ciphering key(s) provided to the UE, the AMF may increase by one the number of UEs that have been provided with the ciphering key(s) (or, the number of UEs that have received the ciphering key(s)) for each corresponding network assistance data type and then store it. Alternatively, the AMF may increase by one the number of UEs that have been provided with ciphering key(s) (or the number of UEs that have received ciphering key(s)) for each corresponding ciphering key and for the corresponding network assistance data type.

Upon receiving a Subscription request message from another NF for the number of UEs that have been provided with the ciphering key as to a specific network assistance data type (i.e., GNSS assistance data type), the AMF may perform counting operation for the corresponding network assistance data type (e.g., if the number of UEs that have been provided with the ciphering key applicable to the network assistance data type is increased by one, it is increased by 1; if the ciphering key applicable to the network assistance data type has been provided but its validity time has expired or has been deleted, it is decreased by 1) and store the counting result.

7. The RAN node may forward the Registration accept message to the UE. On the side of the UE, the validity time for the ciphering key begins, and if the UE is currently in the corresponding tracking area, it may start using each ciphering key to decrypt the broadcasted network assistance data. If the UE moves to a TA where the ciphering key is not applied, it stops utilizing the ciphering key. If the validity time of the ciphering key expires, the UE stops utilizing the ciphering key and deletes the ciphering key.

If a ciphering key is included in the Registration accept message, the UE may transmit a Registration Complete message to the AMF to indicate that the ciphering key has been successfully received.

8a. If there is a subscribing NF (e.g., having received the message at step 0), the AMF may transmit a notification message to the subscribing NF (e.g., LMF). In case that an upper threshold is included at step 0, if the number of UEs (i.e., the number of UEs that have been provided with the ciphering key) for the network assistance data type to which another LMF subscribes and area (TA) reaches the upper threshold, a notification message may be transmitted. This message may include the following information.
Network data type, number of UEs provided with the ciphering key, ciphering key ID, TA, RAN node ID, indicator that upper threshold has been reached.

If the received notification message includes an indicator that the upper threshold has been reached, the LMF may transmit a message to the RAN via the AMF to broadcast the network assistance broadcast type corresponding to the indicated area (TA(s), RAN node ID(s)).

9. The AMF deletes all information about the ciphering key when the validity time expires. If there is a network assistance data type to be counted among the applicable network assistance data types of the deleted key, the AMF may decrease by one the number of UEs that have been provided with the ciphering key for each corresponding network assistance data type.

9a. If there is a subscribing NF (e.g., having received the message at step 0), the AMF may transmit a notification message to the subscribing NF (e.g., LMF). In case that a lower threshold is included at step 0, if the number of UEs (i.e., the number of UEs that have been provided with the ciphering key) for a network assistance data type to which another LMF subscribes and area reaches the lower threshold, a notification message may be transmitted. This message may include the following information.
Network data type, number of UEs provided with the ciphering key, ciphering key ID, TA, RAN node ID, indicator that lower threshold has been reached.

If the received notification message includes an indicator that the lower threshold has been reached, and if the network assistance broadcast type corresponding to the indicated area (TA(s), RAN node ID(s)) is being broadcast, the LMF may transmit a message to the RAN via the AMF to stop the broadcast.

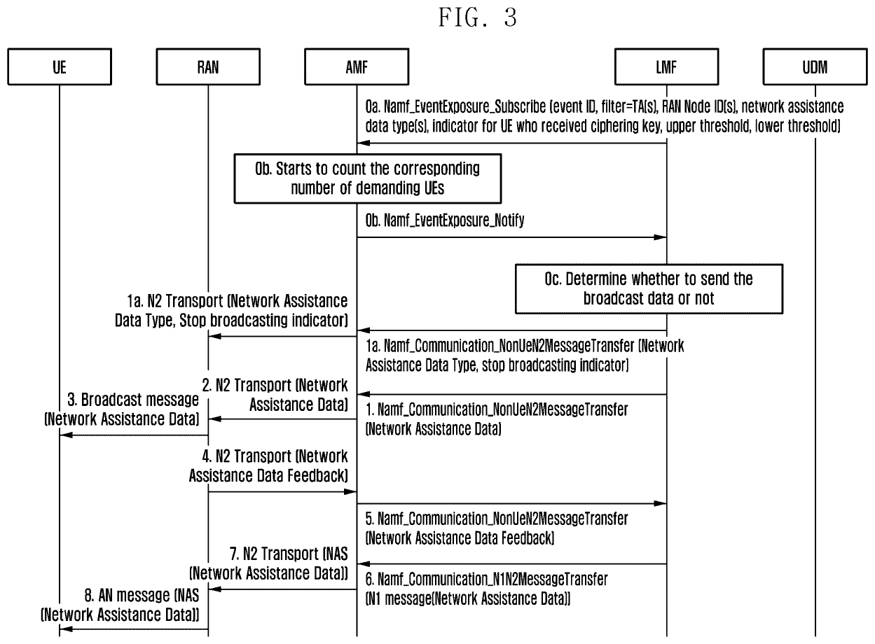

FIG. 3 illustrates a method for broadcasting network assistance data based on various numbers of UEs according to various embodiments of the disclosure.

0a. To determine whether to transmit broadcast information about a network assistance data type to the base station, the LMF may transmit a subscription request message to the AMF to obtain information about the number of UEs that require the corresponding network assistance data type.

This message may include the following information:
Event ID: an event ID indicating the number of UEs in a geographical area is included; and/or
Network assistance data type(s): the network assistance data type to subscribe to may be included. If using a ciphering key (e.g., network assistance data type using ciphering key), the LMF may include an indication for requesting the number of UEs that have been provided with the ciphering key (request indicator for UEs provided with the ciphering key).

If not using a ciphering key, the LMF may include an indicator requesting the number of UEs having subscribed to the network assistance data (request indicator for UEs who subscribed to the network assistance data):
Area information: the TA(s) or RAN node ID(s) to subscribe to may be included; Upper threshold: an upper threshold may be included if the LMF requests event reporting (notification) when the number of UEs of interest reaches the upper threshold; and/or
Lower threshold: a lower threshold may be included if the LMF requests event reporting (notification) when the number of UEs of interest reaches the lower threshold.

Alternatively, the LMF may include an indicator requesting the number of UEs requesting network assistance data (request indicator for UEs who requested the network assistance data via MO-LR (mobile originated location request)):
Area information: the TA(s) or RAN node ID(s) to subscribe to may be included;
Upper threshold: an upper threshold may be included if the LMF requests event reporting (notification) when the number of UEs of interest reaches the upper threshold. If multiple request indicators are included, thresholds may also be included respectively for individual UEs or types; and/or
Lower threshold: a lower threshold may be included if the LMF requests event reporting (notification) when the number of UEs of interest reaches the lower threshold. If multiple request indicators are included, thresholds may also be included respectively for individual UEs or types.

The LMF may include an event ID indicating the number of UEs in a geographical area. The LMF may include one or more of a request indicator for UEs that have requested the network assistance data via mobile originated location request (MO-LR), a request indicator for UEs that have subscribed to the network assistance data, and a request indicator for UEs that have been provided with the ciphering key.

0b. If the message received at step 0a includes a network assistance data type, an indicator for UEs having been provided with the ciphering key, and area information (e.g., TA(s) and/or NG-RAN node ID(s)), the AMF may count the number of UEs having received the ciphering key for the network assistance data type among the UEs located in the corresponding area (TA and/or NG-RAN node ID).

If the message received at step 0a includes an indicator for UEs having subscribed to the network assistance data and area information (e.g., TA(s) and/or NG-RAN node ID(s)), the AMF may count of the number of UEs that include the network assistance data type corresponding to the subscriber information among the UEs located in the corresponding area (TA and/or NG-RAN node ID).

If the message received at step 0a includes a request indicator for UEs having requested the network assistance data via MO-LRs and area information (e.g., TA(s) and/or NG-RAN node ID(s)), the AMF may count the number of UEs that have transmitted a request message for the corresponding network assistance data type by transmitting an MO-LR among the UEs located in the corresponding area (TA and/or NG-RAN node ID).

If the message received at step 0a includes a network assistance data type, one or more request indicators, and area information (e.g., TA(s) and/or NG-RAN node ID(s)), the AMF may transmit a notification message to the LMF including the request indicator, the network assistance data type, and the number of UEs corresponding to the area information (TA and/or NG-RAN node ID).

In case that a lower threshold is included at step 0, if, for a network assistance data type to which another LMF subscribes and area (TA and/or NG-RAN node ID), the number of UEs (e.g., the number of UEs that have been provided with the ciphering key, the number of UEs that have the network assistance data type in their subscription information, or the number of UEs that have requested the network assistance data type via MO-LRs) reaches the lower threshold, the AMF may transmit a notification message to the LMF. In case that an upper threshold is included at step 0, if the number of UEs (i.e., the number of UEs that have been provided with the ciphering key) for the network assistance data type to which another LMF subscribes and area (TA and/or NG-RAN node ID) reaches the upper threshold, the AMF may transmit a notification message to the LMF.

The notification message transmitted by the AMF to the LMF may include the following information. In this case, whether to include the information about the number of UEs may be determined depending on the request indicator received from the AMF:
Network assistance data type;
TA, RAN node ID: indicates information about the area related to the number of UEs included in the notification. If the number of UEs is related to the same area as the area information included in the subscription request message, it may be omitted;
Transaction ID: indicates the identifier for the subscription;
Number of UEs provided with the ciphering key: the number of UEs that have been provided with the ciphering key may be included;
Ciphering key ID; Number of UEs having subscribed to the network assistance data type: the number of UEs that have the network assistance data type in their subscription information;
Number of UEs having requested the network assistance data type via MO-LR: the number of UEs that have requested the network assistance data type via MO-LRs;
Indicator that lower threshold has been reached: an indicator may be included to indicate that the lower threshold has been reached. If multiple request indicators are included, the corresponding indicators may also be included respectively for individual UEs or types; and/or
Indicator that upper threshold has been reached: an indicator may be included to indicate that the upper threshold has been reached. If multiple request indicators are included, the corresponding indicators may also be included respectively for individual UEs or types.

0c. If an indicator that the lower threshold has been reached is included in the received notification message, or if the number of UEs having been provided with the ciphering key, the number of UEs having subscribed to the network assistance data type, and/or the number of UEs having requested the network assistance data type via MO-LRs included in the received notification message have reached their corresponding lower threshold set in the LMF, and if a broadcast request message has already been transmitted for the network assistance data type corresponding to the area (TA(s), RAN node ID(s)), then the LMF may transmit a message to the RAN via the AMF to stop the broadcast for the network assistance data type. In this case, step 1a may be performed.

If an indicator that the upper threshold has been reached is included in the received notification message, or if the number of UEs having been provided with the ciphering key, the number of UEs having subscribed to the network assistance data type, and/or the number of UEs having requested the network assistance data type via MO-LRs included in the received notification message have reached their corresponding upper threshold set in the LMF, and if a broadcast request message has not been transmitted for the network assistance data type corresponding to the area (TA(s), RAN node ID(s)), then the LMF may perform step 1 to carry out the broadcast.

0c. If an indicator that the lower threshold has been reached is included in the received notification message, and if the network assistance broadcast type corresponding to the area (TA(s), RAN node ID(s)) is being broadcast, then the LMF may transmit a message to the RAN via the AMF to stop the broadcast.

1a. The LMF may include an indicator indicating to stop network assistance data broadcasting, network assistance data type, target NG-RAN node ID and/or target TAI (or TAC) in the Namf_Communication_NonUeN2MessageTransfer message to be transmitted to the AMF. Upon receiving this message from the LMF, the AMF may transmit, to the RAN node, an N2 Transport message including an indicator indicating to stop broadcasting for the target NG-RAN node ID or NG-RAN node(s) included in the target TA, the network assistance data type, and a routing indicator indicating the LMF ID. Upon receiving the N2 Transport message from the AMF, the NG-RAN may stop broadcasting of the network assistance data type (i.e., no longer include the corresponding positioning SIB type in the broadcast message).

1. The LMF invokes the Namf_Communication_NonUeN2MessageTransfer service operation towards the AMF to request transmission of a network assistance data message to the NG-RAN node (gNB or ng-eNB) in the NG-RAN. This service operation may include a network assistance data message, a target NG-RAN node identity, and/or a target tracking area (TA) (e.g., tracking area code(s) (TAC) or tracking area identifier(s) (TAI)). The network assistance data message may include network assistance data (i.e., network assistance data for one or more network assistance data types) that may be optionally encrypted based on a ciphering key. The LMF may transmit one or more GNSS assistance data sets to the target NG-RAN node or target NG-RAN node(s) included in the target TA(s).

2. The AMF forwards the network assistance data message to the target NG-RAN node or target TA(s) indicated at step 1 through an N2 Transport message. The AMF includes a routing identifier identifying the LMF in the N2 Transport message. The routing identifier may represent the LMF ID.

If no target NG-RAN node supports network assistance data broadcasting (or, not support the LCS (location services)), the AMF may immediately transmit a response message for step 1 to the LMF without transmitting the network assistance data message. Here, the response message may include a cause indicating no support from the target NG-RAN along with a result indicating a failure. If some of the target NG-RAN nodes do not support network assistance data broadcasting (or, not support the LCS), the AMF may transmit the network assistance data message only to those target NG-RAN nodes that support it, and may transmit the identifier information of those target NG-RAN nodes that do not support it to the LMF. This may be transmitted as a response message for step 1 or as a separate notification message.

3. The NG-RAN node may broadcast assistance data included in the network assistance data message.

4. The target NG-RAN node may transmit feedback on assistance information broadcasting to the AMF through a network assistance feedback message. The target NG-RAN node may include a routing identifier in the N2 Transport message received at step 2.

5. The AMF invokes a Namf_Communication_NonUeN2InfoNotify service operation towards the LMF indicated by the routing identifier received at step 4. This service operation may include the network assistance data feedback message received at step 4.

6. If there are UEs that have the network assistance data type included in the subscriber information but have determined not to perform broadcasting at step 0c, the LMF may transmit the network assistance data to these UEs through the NAS. The LMF may include an N1 message (network assistance data type) in the message transmitted to the AMF.

7. The AMF may include information contained in the N1 message included in the message received from the LMF in a NAS message and transmit the NAS message to the RAN node.

8. The RAN may forward the NAS message received from the AMF to the UE.

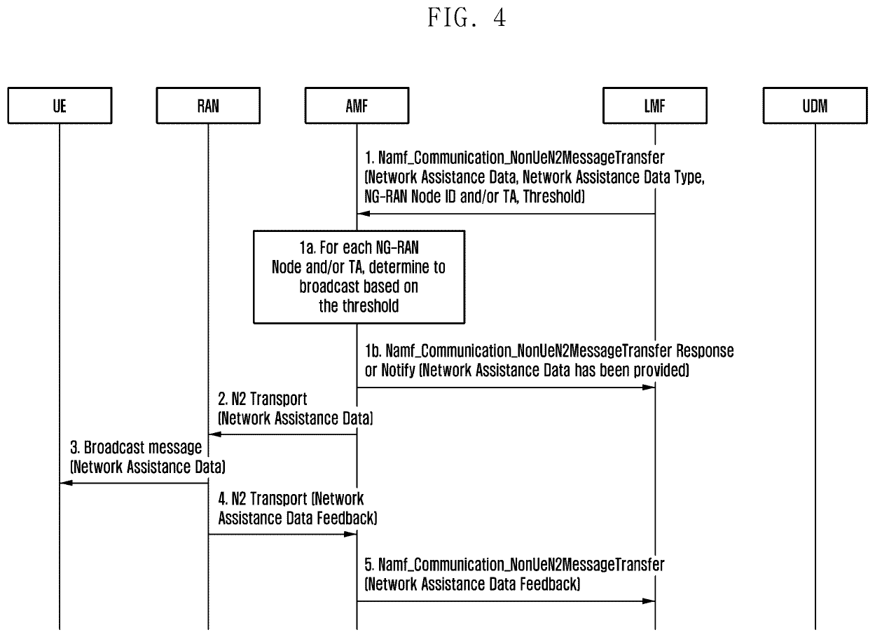

FIG. 4 illustrates a method for determining whether to provide assistance data based on the AMF according to various embodiments of the disclosure.

1. The LMF invokes the Namf_Communication_NonUeN2MessageTransfer service operation towards the AMF to request transmission of a network assistance data message to the NG-RAN node (gNB or ng-eNB). The request for network assistance data message transmission may include network assistance data, network assistance data type, target NG-RAN node identity, and/or target tracking area (TA) (e.g., tracking area code(s) (TAC) or tracking area identifier(s) (TAI)). The network assistance data message may include network assistance data (i.e., network assistance data for one or more network assistance data types) that may be optionally encrypted based on a ciphering key. The LMF may transmit one or more GNSS assistance data sets to the target NG-RAN node or target NG-RAN node(s) included in the target TA(s).

Additionally, the LMF may include a threshold for the number of UEs in the message transmitted to the AMF.

1a. If a network assistance data type and corresponding area information (target NG-RAN node ID, or TA ID) are included in the message received from the LMF, and if a threshold is included in the message received from the LMF, the AMF may transmit the N2 Transport message only when the number of UEs having subscriber information as to the corresponding network assistance data type (e.g., the corresponding type is included in the network assistance data type list that may be received through an MO-LR and in subscriber information, or the corresponding type is included in the network assistance data type list that may be received via broadcasting and in subscriber information) is higher than the threshold among the UEs located in the corresponding area.
1b. If the transmission is successful, the AMF may transmit a response or notification message for Namf_Communication_NonUeN2MessageTransfer to the LMF. The notification message transmitted by the AMF to the LMF may include an indicator that the threshold has been reached and the network assistance data transmission is successful.

After receiving the message of step 1, the AMF may start an internally configured timer. The AMF may transmit the message of step 2 to the RAN node if the number of UEs does not reach the threshold before the timer expires.
2. The AMF may forward the network assistance data message to the target NG-RAN node or Target TA(s) indicated at step 1 via an N2 Transport message. The AMF may include a routing identifier identifying the LMF in the N2 Transport message. The routing identifier may represent the LMF ID.

If no target NG-RAN node supports network assistance data broadcasting (or, not support the LCS), the AMF may immediately transmit a response message for step 1 to the LMF without transmitting the network assistance data message. The response message transmitted in this case may include a cause indicating no support from the target NG-RAN along with a result indicating a failure. If some of the target NG-RAN nodes do not support network assistance data broadcasting (or, not support the LCS), the AMF may transmit the network assistance data message only to those target NG-RAN nodes that support it, and may transmit the identifier information of those target NG-RAN nodes that do not support it to the LMF. This may be transmitted as a response message for step 1 or as a separate notification message.
3. The NG-RAN node may broadcast assistance data included in the network assistance data message.
4. The target NG-RAN node may transmit feedback on assistance information broadcasting to the AMF through a network assistance feedback message. The target NG-RAN node may include a routing identifier in the N2 Transport message received at step 2.
5. The AMF invokes a Namf_Communication_NonUeN2InfoNotify service operation towards the LMF indicated by the routing identifier received at step 4. The message transmitted by the AMF to the LMF may include the network assistance data feedback message received at step 4.

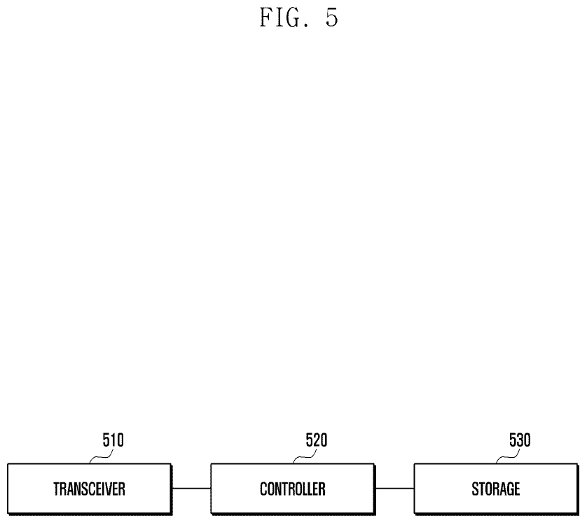

FIG. 5 illustrates a structure of a user equipment (UE) according to various embodiments of the disclosure.

With reference to FIG. 5, the UE may include a transceiver 510, a controller 520, and a storage 530. In the disclosure, the controller may be defined as a circuit, an application-specific integrated circuit, or at least one processor.

The transceiver 510 may transmit and receive signals to and from other network entities. The transceiver 510 may receive data broadcast from, for example, a RAN node.

The controller 520 may control the overall operation of the UE according to the embodiments provided in the disclosure. For example, the controller 520 may control the UE to transmit a registration request message to the RAN node.

The storage 530 may store at least one of the information transmitted and received through the transceiver 510 or the information generated through the controller 520.

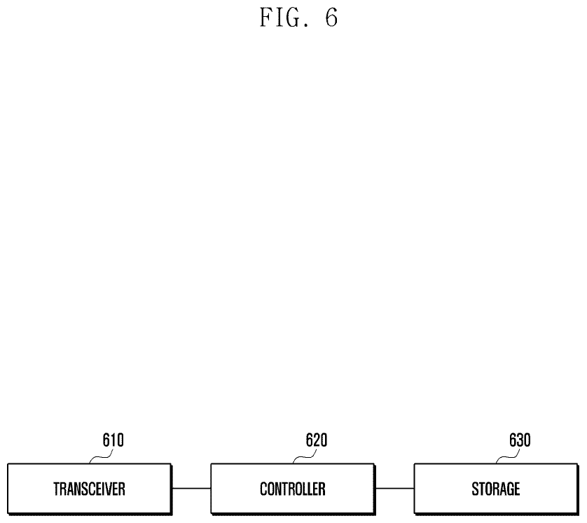

FIG. 6 illustrates a structure of a network entity according to various embodiments of the disclosure.

The network entity illustrated in FIG. 6 may be composed of one of various types of network entities disclosed in the disclosure, such as UPF, AMF, SMF, PCF, UDM, NEF, AUSF, and NSSF.

With reference to FIG. 6, the network entity may include a transceiver 610, a controller 620, and a storage 630. In the disclosure, the controller may be defined as a circuit, an application-specific integrated circuit, or at least one processor.

The transceiver 610 may transmit and receive signals to and from other network entities. The transceiver 610 may receive request messages for various information from, for example, a UE, a base station, or another network entity.

The controller 620 may control the overall operation of the network entity according to embodiments provided in the disclosure.

The storage 630 may store at least one of the information transmitted and received through the transceiver 610 or the information generated through the controller 620.

It should be noted that the block diagrams, schematic diagrams of control/data signal transmission and reception methods, and schematic operational procedure diagrams shown in FIGS. 1 to 6 are not intended to limit the scope of the embodiments of the disclosure. That is, any component, entity, or operational step depicted in FIGS. 1 to 6 should not be construed as an essential element for carrying out the disclosure, and the disclosure may be implemented with only some components within a range that does not impair the subject matter.

The above-described operations of the embodiments may be realized by providing a memory storing the corresponding program codes in a specific component of the equipment. That is, the controller of the equipment may perform the above-described operations by causing a processor or CPU (central processing unit) to read and execute the program codes stored in the memory.

The various components and modules of the entity or terminal described herein may be realized or operated by using hardware (e.g., complementary-metal-oxide-semiconductor based logic circuit), firmware, software, or software embedded in a machine readable medium, or any combination thereof. For example, various electrical structures and methods may be realized by using electrical circuits such as transistors, logic gates, or application specific integrated circuits.

The methods according to the embodiments described in the claims or specification of the disclosure may be implemented in the form of hardware, software, or a combination thereof.

When implemented in software, a computer-readable storage medium storing one or more programs (software modules) may be provided. The one or more programs stored in the computer-readable storage medium may be configured to be executable by one or more processors of an electronic device. The one or more programs may include instructions that cause the electronic device to execute the methods according to the embodiments described in the claims or specification of the disclosure.

Such a program (software module, software) may be stored in a random access memory, a nonvolatile memory such as a flash memory, a read only memory (ROM), an electrically erasable programmable read only memory (EEPROM), a magnetic disc storage device, a compact disc ROM (CD-ROM), a digital versatile disc (DVD), other types of optical storage devices, or a magnetic cassette. Or such a program may be stored in a memory composed of a combination of some or all of them. In addition, a plurality of component memories may be included.

In addition, such a program may be stored in an attachable storage device that can be accessed through a communication network such as the Internet, an intranet, a local area network (LAN), a wide area network (WAN), or a storage area network (SAN), or through a communication network composed of a combination thereof. Such a storage device may access the equipment that carries out an embodiment of the disclosure through an external port. In addition, a separate storage device on a communication network may access the equipment that carries out an embodiment of the disclosure.

In the embodiments of the disclosure described above, the elements included in the disclosure are expressed in a singular or plural form according to the presented specific embodiment. However, the singular or plural expression is appropriately selected for ease of description according to the presented situation, and the disclosure is not limited by a single element or plural elements. Those elements described in a plural form may be configured as a single element, and those elements described in a singular form may be configured as plural elements.

Meanwhile, specific embodiments have been described in the detailed description of the disclosure, but various modifications are possible without departing from the scope of the disclosure. Therefore, the scope of the disclosure should not be limited to those embodiments described above, but should be determined according to the patent claims described later and their equivalents.

The electronic device implementing, operating, and performing various embodiments of the disclosure may be one of various types of devices. The electronic device may include, for example, a portable communication device (e.g., smartphone), a computer device, a portable multimedia device, a portable medical instrument, a camera, a wearable device, or a home appliance. The electronic device according to an embodiment of the disclosure is not limited to those described above.

Various embodiments of the disclosure and terms used therein are not intended to limit the technical features described in this document to specific embodiments, and should be understood as including various modifications, equivalents, or substitutes of a corresponding embodiment. With regard to the description of the drawings, similar reference numerals may be used to refer to similar or related elements. A singular form of a noun corresponding to a specific item may include one or multiple instances of the item unless the relevant context clearly indicates otherwise. In the disclosure, each of phrases such as “A or B,” “at least one of A and B,” “at least one of A or B,” “A, B or C,” “at least one of A, B and C,” and “at least one of A, B or C” may include any one of or all possible combinations of the items enumerated together in the corresponding one of the phrases. Terms such as “1st” and “2nd,” or “first” and “second” may be used to simply distinguish a corresponding component from another, and does not limit the components in other aspect (e.g., importance or order). When an element (e.g., first element) is referred to, with or without the term “operably” or “communicatively,” as “coupled to/with” or “connected to/with” another element (e.g., second element), this means that the element may be connected or coupled to the other element directly (e.g., wiredly), wirelessly, or via a third element.

The term “module” used in various embodiments of the disclosure may include a unit implemented in hardware, software, or firmware, and may be used interchangeably with other terms, for example, “logic,” “logic block,” “component,” or “circuit.” A module may be a single integral component, or a minimum unit or part thereof performing one or more functions. For example, according to an embodiment, a module may be implemented in a form of an application-specific integrated circuit (ASIC).

Various embodiments of the disclosure may be implemented as software (e.g., programs) including one or more instructions that are stored in a storage medium (e.g., internal memory or external memory) readable by a machine (e.g., electronic device). For example, a processor (e.g., processor) of the machine (e.g., electronic device) may invoke at least one of the one or more instructions stored in the storage medium to execute it. This allows the machine to be operated to perform at least one function according to the invoked at least one instruction. The one or more instructions may include a code generated by a complier or a code executable by an interpreter. The machine-readable storage medium may be provided in the form of a non-transitory storage medium. Here, the term “non-transitory” simply means that the storage medium is a tangible device and does not include a signal (e.g., electromagnetic wave), but this term does not distinguish whether data is stored semi-permanently or temporarily in the storage medium.

According to an embodiment, a method according to various embodiments of the disclosure may be provided by being included in a computer program product. The computer program product may be traded as a commodity between a seller and a purchaser. A computer program product may be distributed in the form of a machine-readable storage medium (e.g., compact disc read only memory (CD-ROM)) or be distributed online (e.g., download or upload) directly between two user devices (e.g., smartphones) through an application store (e.g., PlayStore™). For on-line distribution, at least a portion of the computer program product may be temporarily stored or temporarily created in a machine readable storage medium such as a memory of a manufacturer's server, an application store's server, or a relay server.

According to various embodiments, each component (e.g., module or program) of the above-described components may include a single entity or multiple entities, and some of the multiple entities may be separately arranged on other components. According to various embodiments, one or more components or operations may be omitted from the above-described components, or one or more other components or operations may be added. Alternatively or additionally, a plurality of components (e.g., modules or programs) may be integrated into a single component. In this case, the integrated component may perform one or more functions of each of the plurality of components in the same or similar manner as they are performed by a corresponding one of the plurality of components before the integration. According to various embodiments, operations performed by a module, a program, or another component may be carried out in sequence, in parallel, by repetition, or heuristically, or one or more of the operations may be executed in a different order or may be omitted, and one or more other operations may be added.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a location management function (LMF) in a wireless communication system, the method comprising:
transmitting, to an access and mobility management function (AMF), a subscription request message including an assistance data type and an event identifier (ID) requesting a first number of user equipments (UEs) in a geographical area;
receiving, from the AMF, the first number of UEs in the geographical area, wherein the UEs are associated with the assistance data type;
determining whether to broadcast network assistance data based on the first number of UEs in the geographical area; and
transmitting, to the AMF, a transfer request message including network assistance data in response to determining that the network assistance data is broadcast.

2. The method of claim 1, wherein the subscription request message further includes an indicator requesting a second number of UEs provided with a ciphering key, and
wherein the first number of UEs in the geographical area indicates the second number of UEs provided with the ciphering key.

3. The method of claim 1, wherein the subscription request message further includes a threshold value for the first number of UEs in the geographical area.

4. The method of claim 1, wherein the geographical area corresponds to a tracking area identity (TAI).

5. The method of claim 1, wherein the UEs are associated with a mobile-originated location request (MO-LR).

6. A method performed by an access and mobility management function (AMF) in a wireless communication system, the method comprising:
receiving, from a location management function (LMF), a subscription request message including an assistance data type and an event identifier (ID) indicating a first number of user equipments (UEs) in a geographical area;
transmitting, to the LMF, the first number of UEs in the geographical area, wherein the UEs are associated with the assistance data type;
receiving, from the LMF, a transfer request message including network assistance data; and
transmitting, to a radio access network (RAN) node, the network assistance data.

7. The method of claim 6, wherein the subscription request message further includes an indicator requesting a second number of UEs provided with a ciphering key, and
wherein the first number of UEs in the geographical area indicates the second number of UEs provided with the ciphering key.

8. The method of claim 6, wherein the subscription request message further includes a threshold value for the first number of UEs in the geographical area, and a transmission of the first number of UEs in the geographical area is performed based on the threshold value.

9. The method of claim 6, wherein the geographical area corresponds to a tracking area identity (TAI).

10. The method of claim 6, wherein the UEs are associated with a mobile-originated location request (MO-LR).

11. A location management function (LMF) in a wireless communication system, the LMF comprising:
a transceiver; and
a controller coupled with the transceiver and configured to:
transmit, to an access and mobility management function (AMF), a subscription request message including an assistance data type and an event identifier (ID) requesting a first number of user equipments (UEs) in a geographical area,
receive, from the AMF, the first number of UEs in the geographical area, wherein the UEs are associated with the assistance data type,
determine whether to broadcast network assistance data based on the first number of UEs in the geographical area, and
transmit, to the AMF, a transfer request message including network assistance data in response to determining that the network assistance data is broadcast.

12. The LMF of claim 11, wherein the subscription request message further includes an indicator requesting a second number of UEs provided with a ciphering key, and
wherein the first number of UEs in the geographical area indicates the second number of UEs provided with the ciphering key.

13. The LMF of claim 11, wherein the subscription request message further includes a threshold value for the first number of UEs in the geographical area.

14. An access and mobility management function (AMF) in a wireless communication system, the AMF comprising:
a transceiver; and
a controller coupled with the transceiver and configured to:
receive, from a location management function (LMF), a subscription request message including an assistance data type and an event identifier (ID) indicating a first number of user equipments (UEs) in a geographical area,
transmit, to the LMF, the first number of UEs in the geographical area, wherein the UEs are associated with the assistance data type,
receive, from the LMF, a transfer request message including network assistance data, and
transmit, to a radio access network (RAN) node, the network assistance data.

15. The AMF of claim 14, wherein the subscription request message further includes an indicator requesting a second number of UEs provided with a ciphering key, and
wherein the first number of UEs in the geographical area indicates the second number of UEs provided with the ciphering key.

16. The AMF of claim 14, wherein the subscription request message further includes a threshold value for the first number of UEs in the geographical area, and a transmission of the first number of UEs in the geographical area is performed based on the threshold value.

17. The AMF of claim 14, wherein the geographical area corresponds to a tracking area identity (TAI).

18. The AMF of claim 14, wherein the UEs are associated with a mobile-originated location request (MO-LR).
